(19) United States
(12) Patent Application Publication
(10) Pub. No.: US 2025/0050854 A1
(43) Pub. Date: Feb. 13, 2025

(54) BRAKE SYSTEMS WITH MOTOR-DRIVEN MASTER CYLINDERS AND ELECTRIC SECONDARY POWER TRANSMISSION UNITS

(71) Applicant: ZF Active Safety US Inc., Livonia, MI (US)

(72) Inventor: Blaise J. Ganzel, Ann Arbor, MI (US)

(21) Appl. No.: 18/447,541

(22) Filed: Aug. 10, 2023

(51) Int. Cl. B60T 13/16; B60T 13/68; B60T 13/74

(52) U.S. Cl. CPC B60T 13/165; B60T 13/686; B60T 13/745; B60T 2220/04

(57) ABSTRACT

A brake system for actuating a plurality of wheel brakes comprising first and second pairs of wheel brakes includes a reservoir and a motor-driven master cylinder operable during a normal non-failure braking mode to generate brake actuating pressure at first and second MC outputs for hydraulically actuating the first and second pairs of wheel brakes. A secondary power transmission unit is configured for selectively providing pressurized hydraulic fluid at first and second PTU outputs and includes an electric PTU motor configured to selectively pressurize the hydraulic fluid by transmitting rotary motion to at least two pump pistons. The secondary power transmission unit is indirectly fluidly connected to the reservoir to selectively draw hydraulic fluid therefrom.

### RELATED APPLICATIONS

This application is related to the technologies disclosed in one or more of U.S. Provisional Patent Application No. [PENDING] (attorney docket no. 300063-US-PSP[3]), filed concurrently herewith and titled “PUSH THRU SCA”; U.S. patent application Ser. No. 18/447,490 (attorney docket no. 300080-US-NP), filed concurrently herewith and titled “Brake Systems with Master Cylinders and Single Corner Actuators”; U.S. patent application No. [PENDING] (attorney docket no. 300510-US-NP), filed concurrently herewith and titled “Brake Systems with Motor-Driven Master Cylinders and Wheel-Side Pressure Sensors”; U.S. patent application No. [PENDING] (attorney docket no. 300642-US-NP), filed concurrently herewith and titled “Venting Valve and Brake Systems Using Same”; and U.S. patent application No. [PENDING] (attorney docket no. 301149-US-NP), filed concurrently herewith and titled “Bleed Valve and Brake Systems Using Same”; the entire contents of all of which are incorporated herein by reference for all purposes.

### TECHNICAL FIELD

This disclosure relates to an apparatus and method for use of brake systems with motor-driven master cylinders and electric secondary power transmission units, and, more particularly, to methods and apparatus of brake systems in which the electric secondary power transmission units are in indirect fluid connection with a reservoir for replenishment.

### BACKGROUND

A brake system may include anti-lock control including a hydraulic braking pressure generator, a braking pressure modulator which is provided in the pressure fluid conduits between the braking pressure generator and the wheel brakes and which serves to vary the braking pressure by changing the volume of a chamber containing the hydraulic fluid, sensors for determining the wheel rotational behavior, and electronic circuits for processing the sensor signals and for generating braking-pressure control signals. Brake systems may also include both anti-lock control and traction slip control, which can use braking pressure modulators for controlled vehicular braking.

Descriptions of prior art brake systems are in U.S. Pat. No. 10,730,501, issued 4 Aug. 2020 to Blaise Ganzel and titled “Vehicle Brake System with Auxiliary Pressure Source”, in U.S. Patent Application Publication No. 2020/0307538, published Jan. 10, 2020 by Blaise Ganzel and titled “Brake System with Multiple Pressure Sources”, and in U.S. patent application Ser. No. 17/400,250, filed 12-8-2021 by Blaise Ganzel and titled “Apparatus and Method for Control of a Hydraulic Brake System Including Manual Pushthrough”, all of which are incorporated herein by reference in their entirety for all purposes.

### SUMMARY

In an aspect, a brake system for actuating a plurality of wheel brakes comprising first and second pairs of wheel brakes is disclosed. The system includes a reservoir and a motor-driven master cylinder operable during a normal non-failure braking mode by actuation of an electric motor of the master cylinder to generate brake actuating pressure at first and second MC outputs for hydraulically actuating the first and second pairs of wheel brakes. A secondary power transmission unit is configured for selectively providing pressurized hydraulic fluid at first and second PTU outputs for actuating the first and second pairs of wheel brakes in at least one of a normal non-failure braking mode and a backup braking mode. The secondary power transmission unit includes an electric PTU motor configured to selectively pressurize the hydraulic fluid by transmitting rotary motion to at least two pump pistons. Each pump piston provides pressurized hydraulic fluid to a corresponding one of the first and second PTU outputs. Each of the first and second PTU outputs provides fluid to a corresponding one of the first and second pairs of wheel brakes. An electronic control unit is provided for controlling at least one of the power transmission unit and the master cylinder. The secondary power transmission unit is indirectly fluidly connected to the reservoir to selectively draw hydraulic fluid therefrom.

### BRIEF DESCRIPTION OF THE DRAWINGS

For a better understanding, reference may be made to the accompanying drawings, in which:

FIG. 1 is a schematic hydraulic diagram of an example brake system according to an aspect of the present invention; and

FIG. 2 is a schematic hydraulic diagram of the example brake system of FIG. 1 in an alternate configuration.

### DESCRIPTION OF ASPECTS OF THE DISCLOSURE

Unless defined otherwise, all technical and scientific terms used herein have the same meaning as is commonly understood by one of ordinary skill in the art to which the present disclosure pertains.

The invention comprises, consists of, or consists essentially of the following features, in any combination.

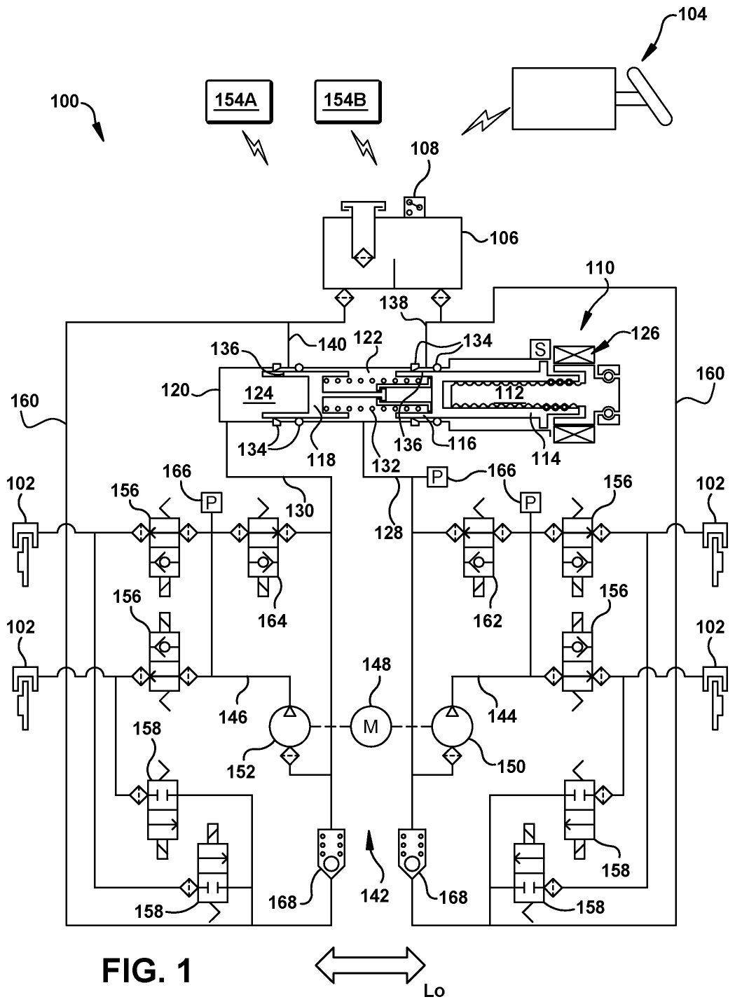

FIG. 1 schematically depicts an example brake system 100 for actuating a plurality of wheel brakes 102. The brake system 100 is shown here as a hydraulic braking system, in which fluid pressure is utilized to apply braking forces for the brake system 100. The brake system 100 may suitably be used on a ground vehicle, such as an automotive vehicle having four wheels with a wheel brake associated with each wheel. Furthermore, the brake system 100 can be provided with other braking functions such as anti-lock braking (ABS) and other slip control features to effectively brake the vehicle. Components of the brake system 100 may be housed in one or more blocks or housings. The blocks or housings may be made from solid material, such as aluminum, that has been drilled, machined, or otherwise formed to house the various components. Fluid conduits may also be formed in the block or housing.

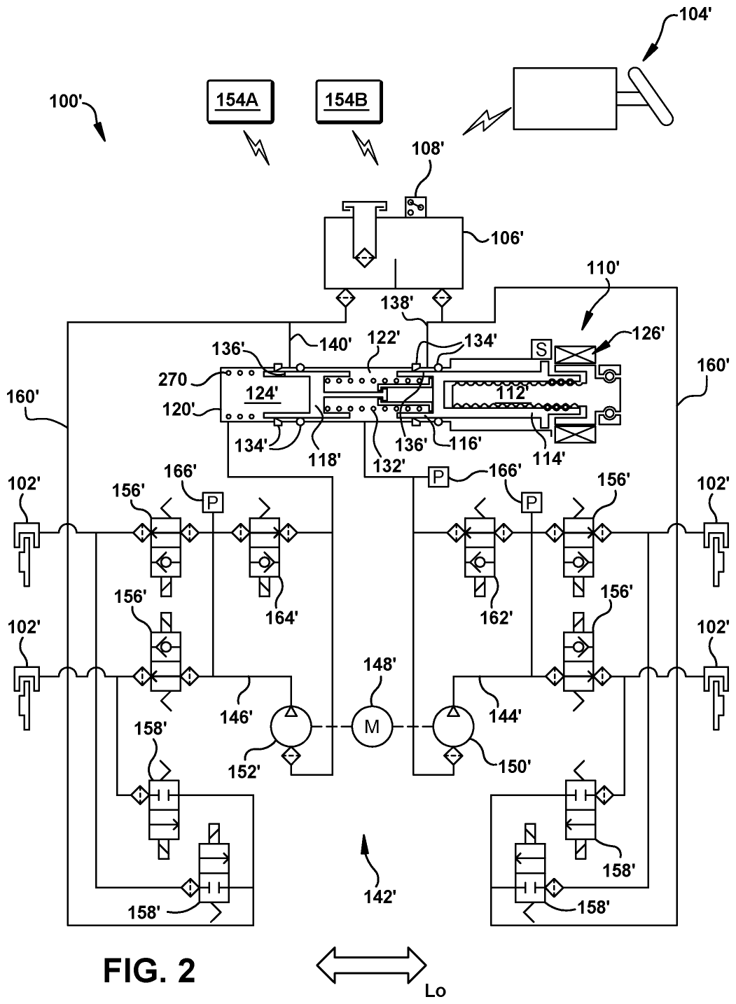

In the illustrated embodiments of the brake system 100 of FIGS. 2, there are four wheel brakes 102, which each can have any suitable wheel brake structure operated electrically and/or by the application of pressurized brake fluid. Each of the wheel brakes 102 may include, for example, a brake caliper mounted on the vehicle to engage a frictional element (such as a brake disc) that rotates with a vehicle wheel to effect braking of the associated vehicle wheel. The wheel brakes 102 can be associated with any combination of front and rear wheels of the vehicle in which the corresponding brake system 100 is installed. For example, the brake system 100 may be configured as a vertically split or diagonally split system. No differentiation is made herein among the wheel brakes 102, for the purposes of this description, though one of ordinary skill in the art could readily provide a suitable braking arrangement for a particular use environment. Two pairs of wheel brakes 102 are shown in the Figures as being separated to the right and left of the included schematics, for the sake of depiction, without regard to the actual position of those wheel brakes 102 on a corresponding vehicle. The right-side pair of wheel brakes 102 (in the orientation of the Figures) will be referenced as a “first” pair of wheel brakes 102, and the left-side pair of wheel brakes 102 (in the orientation of the Figures) will be referenced as a “second” pair of wheel brakes 102.

Also for the sake of description, it is presumed that a deceleration signal transmitter (shown schematically at 104) is configured to provide a braking signal, in a wired or wireless manner, corresponding to a desired braking action by an operator of the vehicle. The deceleration signal transmitter 104 could include, but not be limited to, a brake pedal, an autonomous braking controller, and/or any other suitable scheme for generating a braking signal from which the brake system 100 can be actuated.

The brake system 100 also includes a fluid reservoir 106. The reservoir 106 stores and holds hydraulic fluid for the brake system 100. The fluid within the reservoir 106 is preferably held at or about atmospheric pressure, but the fluid may be stored at other pressures if desired. The reservoir 106 is shown schematically having two tanks or sections with fluid conduit lines connected thereto. The sections can be separated by several interior walls within the reservoir 106 and are provided to prevent complete drainage of the reservoir 106 in case one of the sections is depleted due to a leakage via one of the lines connected to the reservoir 106. Any number of lines could be connected to the reservoir 106, and one of ordinary skill in the art can readily provide a suitably configured reservoir 106 for a particular use environment. Alternatively, the reservoir 106 may include multiple separate housings. The reservoir 106 may include at least one fluid level sensor 108 for detecting the fluid level of one or more of the sections of the reservoir 106.

The brake system 100 includes a motor-driven master cylinder 110 which functions as a source of pressure to provide a desired pressure level to the hydraulically operated wheel brakes 102 during a typical or normal non-failure brake apply. The motor-driven master cylinder (“MC”) 110 shown in the Figures is a dual-chamber type master cylinder. An example of a suitable MC 110 arrangement is disclosed in co-pending U.S. patent application Ser. No. 17/708,070, filed 30 Mar. 2022 and titled “Tandem Power Transmission Unit and Brake Systems Using Same” (attorney docket no. 211835-US-NP), which is incorporated by reference herein in its entirety for all purposes.

The MC 110 includes a ball screw 112, a ball nut 114 selectively driven by the ball screw 112 for longitudinal motion relative thereto, and a primary piston 116 operatively coupled to the ball nut 114 (e.g., via a press-fit connection therebetween). The piston 116 is indirectly driven to reciprocal longitudinal motion by the ball screw 112 via engagement of the piston 116 with the ball nut 114. The term “longitudinal”, as used herein, is substantially in the horizontal direction, in the orientation of FIGS. 1-2, and is indicated by arrow “Lo”. A secondary piston 118 is attached to the primary piston 116, the secondary piston 118 also being indirectly driven by the ball screw 112 via motion transmitted through the primary piston 116.

A block housing (shown schematically at 120) at least partially encloses the primary piston 116, the secondary piston 118, and the ball screw 112. A primary chamber 122 is at least partially defined by the block housing 120 and a face of the primary piston 116. A secondary chamber 124 is at least partially defined by the block housing 120 and a face of the secondary piston 118. The primary and secondary chambers 122 and 124 are each configured to contain hydraulic fluid and are selectively pressurized by reciprocal longitudinal motion of the primary and secondary pistons 116 and 118 with respect to the block housing 120.

An electric motor 126 is provided for selectively driving the ball screw 112 to responsively reciprocate the primary and secondary pistons 116 and 118 within the primary and secondary chambers 122 and 124. The MC 110 is operable in a normal non-failure braking mode by actuation of the electric motor 126 of the MC 110 to generate brake actuating pressure at first and second MC outputs 128 and 130 for hydraulically actuating the first and second pairs of wheel brakes 102, respectively. A spring 132 may be provided in the primary chamber 122 to bias the secondary piston 118 toward the left, in the orientation of the Figures, and thereby facilitate desired operation of the MC 110, and/or the larger brake system 100.

With reference to FIG. 1, each of the primary and secondary chambers 122 and 124 may include at least one annular sealing groove configured to contain an annular seal 134, of any desired type, for resisting egress of hydraulic fluid from the respective primary or secondary chamber 122 or 124 in an undesirable direction. For example, a v-seal could be provided to a rightmost (in the orientation of FIG. 1) sealing groove of at least one of the primary and secondary chambers 122 and 124, and a w-seal, or recup seal, could be provided to a more leftwardly oriented (in the orientation of FIG. 1) sealing groove of at least one of the primary and secondary chambers 122 and 124, to provide desired sealing properties in a particular use environment.

The primary and secondary pistons 116 and 118 also may each include at least one piston port 136 which selectively places the corresponding primary or secondary chamber 122 or 124 into fluid communication with the reservoir 106 via first and second reservoir lines 138 and 140, respectively. Once the primary and secondary pistons 116 and 118 shuttle past the depicted seals 134 (e.g., to the left of the leftmost seal in each corresponding primary or secondary chamber 122 or 124), then the piston port 136 “closes” and blocks fluid communication between that chamber and the reservoir 106.

After a brake apply, fluid from the wheel brakes 102 may be returned to the motor-driven master cylinder 110 and/or be diverted to the reservoir 106. It is also contemplated that other configurations (not shown) of the brake system 100 could include hydraulic control of just selected one(s) of the wheel brakes 102 (with the others being electrically controlled/actuated). One of ordinary skill in the art would be readily able to provide such an arrangement for a desired use environment, following aspects of the present invention.

The brake system 100 includes a secondary power transmission unit (“PTU”) 142 for selectively providing pressurized hydraulic fluid at first and second PTU outputs 144 and 146, respectively, for actuating the corresponding first and second pairs of wheel brakes 102 in at least one of a normal non-failure braking mode and a backup braking mode. That is, each of the first and second PTU outputs 144 and 146 provides fluid to a corresponding one of the first and second pairs of wheel brakes 102.

The secondary PTU 142 includes an electric PTU motor 148 configured to selectively pressurize the hydraulic fluid by transmitting rotary motion to at least two pump pistons 150 and 152, respectively. Each pump piston 150 and 152 provides pressurized hydraulic fluid to a corresponding one of the first and second PTU outputs 144 and 146. In the Figures, each pump piston 150 and 152 is associated with two wheel brakes 102, for a total of two pump pistons 150 and 152 in the brake system 100. It is contemplated, though, that any desired number of pump pistons could be provided to the secondary PTU 142, such as a plurality of pump pistons associated with at least one of the first and second PTU outputs 144 and 146. In many use environments, it may be desirable to have an even number of total pump pistons, to facilitate balance in the mechanism of the secondary PTU 142.

The secondary PTU 142 of the brake system 100 may function as a source of pressure to provide a desired pressure level to selected ones of the wheel brakes 102 in a backup or “failed” situation, when, for some reason, the motor-driven MC 110 is unavailable to provide fluid to those selected wheel brakes 102. The secondary PTU 142 can be used to selectively provide hydraulic fluid to at least one of the wheel brakes 102 in such a backup braking mode, but also in an enhanced braking mode, which can occur on its own and/or concurrently with either the backup braking mode or a non-failure normal braking mode. Examples of suitable enhanced braking mode functions available to the brake system 100 include, but are not limited to, “overboost” (in which higher pressure is provided to a particular brake than would normally be available from the PTU 100 alone) and “volume-add” (in which more fluid is provided to a particular brake than would normally be available from the PTU 100). As another example, the secondary PTU 142 could be operative to provide pressurized hydraulic fluid to at least one of the first and second pairs of wheel brakes 102 in a slip control condition of a normal non-failure braking mode. One of ordinary skill in the art can readily configure a brake system 100 having desired interactions and modes for a particular use environment of the present invention.

The brake system 100 also includes at least one electronic control unit (“ECU”) 154 for controlling at least one of the secondary PTU 142 and the motor-driven MC 110, with first and second ECUs 154A, 154B being shown and described herein. The ECUs 154A, 154B may include microprocessors and other electrical circuitry. The ECUs 154A, 154B receive various signals, process signals, and control the operation of various electrical components of a corresponding brake system 100 in response to the received signals, in a wired and/or wireless manner. For example, the ECU(s) 154A and/or 154B may control at least one of the power transmission unit 142 and the master cylinder 110 responsive to the braking signal generated by the deceleration signal transmitter 104.

The ECUs 154A, 154B can be connected to various sensors such as the reservoir fluid level sensor 108, pressure sensors, travel sensors, switches, wheel speed sensors, and steering angle sensors. The ECUs 154A, 154B may also be connected to an external module (not shown) for receiving information related to yaw rate, lateral acceleration, longitudinal acceleration of the vehicle, or other characteristics of vehicle operation for any reason, such as, but not limited to, controlling the brake system 100 during vehicle braking, stability operation, or other modes of operation. Additionally, the ECUs 154A, 154B may be connected to the instrument cluster for collecting and supplying information related to warning indicators such as an ABS warning light, a brake fluid level warning light, and a traction control/vehicle stability control indicator light. It is contemplated that at least one of the ECUs 154A and 154B may be, for example, integrated into at least one of the motor-driven MC 110 or the secondary PTU 142.

When there are two ECUs provided to the brake system 100, the first ECU 154A may be operative to control the electric motor 126 of the motor-driven MC 110, and any desired one(s) of the valves of the brake system 100, as will be discussed below. The second ECU 154B may be operative to control the PTU motor 428, and any desired one(s) of the valves of the brake system 100, as will be discussed below.

An example of a suitable ECU 154 arrangement is disclosed in co-pending U.S. patent application Ser. No. 17/708,019, filed concurrently herewith and titled “Control Arrangement for a Brake System” (attorney docket no. 211652-US-NP-2, hereafter referenced as “the backed-up ECU”), which is incorporated by reference herein in its entirety for all purposes.

An iso/dump control valve arrangement is associated with each wheel brake 102 of the plurality of wheel brakes 102. Each iso/dump control valve arrangement includes an iso valve 156 and a dump valve 158, for providing desired fluid routing to an associated wheel brake 102. Each iso/dump control valve arrangement is controlled by at least a selected one of the first and second ECUs 154A, 154B, or by the single ECU when only one is present. For some use environments of the brake system 100, it may be desirable for the iso/dump control valve arrangements to be controlled by the same one of the first and second ECUs 154A, 154B which controls the motor-driven MC 110, for control of the wheel brakes 102 during a normal non-failure braking mode.

The reservoir 106 is hydraulically connected to the motor-driven MC 110 and to each of the iso/dump control valve arrangements, such as via the return lines 160. The normally open iso valve 156 for each iso/dump control valve arrangement is located hydraulically between a respective wheel brake 102 and the motor-driven MC 110, and the normally closed dump valve 158 for each iso/dump control valve arrangement is located hydraulically between a respective wheel brake 102 and the reservoir 106, for the corresponding wheel brake 102. Each iso/dump control valve arrangement is in fluid communication with both a selected one of the first and second MC outputs 128 and 130 and a selected one of the first and second PTU outputs 144 and 146 for selectively receiving pressurized hydraulic fluid therefrom.

The iso/dump control valve arrangements may selectively provide slip control to at least one wheel brake 102 powered by the motor-driven MC 110 and/or the secondary PTU 142. More broadly, the iso/dump control valve arrangement, and/or other valves of the brake system 100, any of which may be solenoid-operated and have any suitable configurations, can be used to help provide controlled braking operations, such as, but not limited to, ABS, traction control, vehicle stability control, dynamic rear proportioning, regenerative braking blending, and autonomous braking.

First and second traction control iso valves 162 and 164, respectively, are each hydraulically interposed between the motor-driven MC 110 and at least one wheel brake 102. For example, and as shown in the Figures, the first and second traction control iso valves 162 and 164 may each be hydraulically interposed between the motor-driven MC 110 and at least one iso/dump control valve arrangement via the first and second MC outputs 128 and 130, respectively. The first and second traction control iso valves 198 and 200 are operative to assist with routing hydraulic fluid to the iso/dump control valve arrangements as desired.

Each of the first and second traction control iso valves 198 and 200 is controlled by at least a selected one of the first and second ECUs 154A, 154B, or by the single ECU when only one is present. For some use environments of the brake system 100, it may be desirable for the first and second traction control iso valves 198 and 200 to be controlled by the same one of the first and second ECUs 154A, 154B which controls the motor-driven MC 110, for control of the wheel brakes 102 during a normal non-failure braking mode.

In summary, in the brake systems 100 shown in FIGS. 1-2, at least the first ECU 154A may be operative to control the electric motor 126 of the motor-driven MC 110, the iso/dump control valve arrangements (comprising iso valves 156 and dump valves 158), and at least one of the first and second traction control iso valves 162 and 164 when the brake systems 100 are in a normal non-failure braking mode. Analogously, at least the second ECU 154B is operative to control the electric PTU motor 148 with the pump pistons 150 at least when the brake systems 100 are in the backup braking mode and optionally, as previously mentioned, when the brake systems 100 are in the normal non-failure braking mode, to achieve desired braking response.

At least one pressure sensor 166 (three shown in the Figures) may be provided to sense a pressure of the pressurized hydraulic fluid at one or both of the first and second MC outputs 128 and 130. One or more pressure sensors 166 could be located in direct hydraulic connection with the motor-driven MC 110 and/or in indirect hydraulic connection with the respective first or second MC output 128 or 130, such as by being located downstream of the first or second traction control iso valve 162 or 164. The pressure sensor(s) 166, when present, are operative to provide a pressure signal to at least one of the ECUs 154A and 154B responsive to the sensed pressure. (E.g., at least one pressure sensor 166 associated with the motor-driven MC 110 could be monitored by one ECU 154A or 154B and at least one pressure sensor 166 associated with the electric PTU motor 148 could be monitored by the other ECU 154B or 154A.) One of ordinary skill in the art can readily configure a brake system 100 with a desired number/placement/type of pressure sensors for a particular use environment.

In the brake systems 100 shown and described herein, the secondary PTU 142 pump pistons 202 are indirectly fluidly/hydraulically connected to the reservoir 106 to selectively draw hydraulic fluid therefrom. For example, and as shown in the brake system 100 of FIG. 1, each of the first and second MC outputs 128 and 130 is in fluid communication with a pump input of at least one pump piston 150, 152 for selectively supplying pressurized hydraulic fluid thereto. The secondary PTU 142 selectively boosts pressure of the pressurized hydraulic fluid to supply boosted-pressure hydraulic fluid to at least one of the first and second PTU outputs 144 and 146 in at least one of a normal non-failure braking mode and a backup braking mode. For example, in certain phases of normal non-failure braking mode operation, the motor-driven MC 110 might not be operable to provide a desired amount and/or pressure of pressurized hydraulic fluid to one or more of the wheel brakes 102; in this case, the secondary PTU 142 will act to supplement the motor-driven MC 110. As another example, when the brake system 100 is in a backup braking mode due to unavailability of the motor-driven MC 110 for any reason, the secondary PTU 142 will supplant the motor-driven MC 110 and provide a predetermined amount of pressurized hydraulic fluid to one or more wheel brakes 102 in lieu of the fluid which the affected wheel brake(s) 102 would normally receive from the motor-driven MC 110.

As shown in FIG. 1, the indirect connection between the secondary PTU 142 (i.e., the pump pistons 150, 152 thereof) and the reservoir 106 is made via at least one check valve 168 interposed hydraulically therebetween. In the FIG. 1 arrangement, a different check valve 168 is interposed hydraulically between the reservoir 106 and each of the pump pistons 150, 152, for a total of two check valves 168 as shown, but any desired number of check valves 168 could be provided for a particular use environment of the brake system 100. In the brake system 100 as shown in FIG. 1, each check valve 168 will open to permit passage therethrough of hydraulic fluid from the reservoir 106 when pressure in the corresponding pump piston 150, 152 is high enough to overcome the biasing force of the check valve 168 and “suck” fluid from the reservoir 106 to maintain a desired amount of fluid in, and downstream of, the respective pump piston 150, 152.

In summary, as shown in the brake system 100 of FIG. 1, the secondary PTU 142 can selectively pull hydraulic fluid from the reservoir 106 through the at least one check valve 168 to supplement (which may include completely supplanting) pressurized hydraulic fluid from the motor-driven MC 110. As a result, even if one of the ECUs 154A, 154B is not available to the brake system 100 for some reason, fluid levels in the reservoir 106 can be monitored and adjusted via control of either the electric motor 126 or PTU motor 148, depending upon which of the ECUs 154A, 154B is still available within the brake system 100 at that time.

Stated differently, and as shown in FIG. 1, each pump piston 150, 152 has two associated wheel brakes 102, and provides pressurized hydraulic fluid to the iso/dump control valve arrangement of both of the associated wheel brakes 102 on that same side of the brake system 100; there are a total of two pump pistons 150, 152 in the brake system 100 as shown. In the brake system 100, boosted braking can be provided using the PTU motor 148 acting through the two pump pistons 150, 152, since the pump pistons 150, 152 can pull fluid indirectly from the reservoir 106 via the check valves 168 and are not wholly reliant on fluid coming from the motor-driven MC 110 for operation.

FIG. 2 illustrates a second embodiment of a brake system 100′. The brake system 100′ of FIG. 2 is similar to the brake system 100 of FIG. 1 and therefore, structures of FIG. 2 that are the same as or similar to those described with reference to FIG. 1 have the same reference numbers with the addition of a “prime” mark. Description of common elements and operation similar to those in the previously described first embodiment will not be repeated with respect to the second embodiment, but should instead be considered to be incorporated below by reference as appropriate.

As shown in FIG. 2, the secondary PTU 142′ may selectively pull hydraulic fluid from the reservoir 106′ (indirectly) through the motor-driven MC 110′. That is, in the brake system 100′ as shown in FIG. 2, the passageway(s) within the motor-driven MC 110′ may open to permit passage therethrough of hydraulic fluid from the reservoir 106′ when pressure in the corresponding pump piston 150′, 152′ is low enough to overcome the internal biasing forces of the various components of the motor driven MC 110′ and accordingly “suck” fluid from the reservoir 106 to maintain a desired amount of fluid in, and downstream of, the respective pump piston 150′, 152′.

To facilitate desired opening of fluid passageways through the structures of the motor-driven MC 110′, the motor-driven MC 110′ may include at least one return spring 270 biasing open a replenishment fluid path (e.g., through the leftmost piston port 136′) between the secondary PTU 142′ and the reservoir 106′ responsive to de-energization of the motor-driven MC 110′. When the return spring 270 is present, then the PTU motor 148 does not need to work hard enough to overcome the lip seal cracking pressure and other forces within the primary and/or secondary chambers 122 or 124 to open that replenishment fluid path. As a result of the return spring's 270 presence, the PTU motor 148 can thus be smaller, lighter, and less expensive than it might need to be without the “biasing assist” from the return spring 270, and/or the return spring 270 could obviate the presence of one or more check or other valves (not shown) that otherwise might be needed to provide desired brake system characteristics.

In summary, as shown in the brake system 100′ of FIG. 2, the secondary PTU 142 can selectively pull hydraulic fluid from the reservoir 106 through a replenishment fluid path extending through the motor-driven MC 110′ to supplement (which may include completely supplanting) pressurized hydraulic fluid from the motor-driven MC 110′.

All of the iso valves 192, dump valves 194, and the first and second traction control iso valves 198 and 200 are shown as being single wound in the brake systems 100, 100′ of FIGS. 1-2 and may include dual/redundant electronic control circuits, as desired. Dual-wound valves are contemplated for use, also or instead, in other implementations of the brake systems 100, 100′. When dual-wound valves and/or electric motors 126 and 148 are present, then both of the ECUs 154A, 154B are capable of controlling any one or more of these dual wound valves and motors, under first (normal) and/or second (backup) braking modes.

It is contemplated that the PTU 110 could be located remotely from one or more other components of the brake system 100, which may be desirable for space, manufacturing, and/or any other reason for a particular use environment of the brake system 100. Conversely, the PTU 110 could be co-located with other components of the brake system 100; one of ordinary skill in the art can readily provide a suitably configured brake system 100 as desired.

It is contemplated that various other components, such as electric service and/or parking brake motors, could be provided by one of ordinary skill in the art to achieve desired configurations for particular use environments, in any of the brake systems described herein. For example, while a number of filters and pressure sensors are shown in the Figures, specific description thereof has been omitted herefrom for brevity, as one of ordinary skill in the art will readily understand how to provide a desired number, placement, and/or operation of filters, sensors, and any other components as desired for a particular use environment of the present invention.

As used herein, the singular forms “a”, “an”, and “the” can include the plural forms as well, unless the context clearly indicates otherwise. It will be further understood that the terms “comprises” and/or “comprising”, as used herein, can specify the presence of stated features, steps, operations, elements, and/or components, but do not preclude the presence or addition of one or more other features, steps, operations, elements, components, and/or groups thereof.

As used herein, the term “and/or” can include any and all combinations of one or more of the associated listed items.

It will be understood that when an element is referred to as being “on”, “attached” to, “connected” to, “coupled” with, “contacting”, “adjacent”, etc., another element, it can be directly on, attached to, connected to, coupled with, contacting, or adjacent the other element, or intervening elements may also be present. In contrast, when an element is referred to as being, for example, “directly on”, “directly attached” to, “directly connected” to, “directly coupled” with, “directly contacting”, or “directly adjacent” another element, there are no intervening elements present. It will also be appreciated by those of ordinary skill in the art that references to a structure or feature that is disposed “directly adjacent” another feature may have portions that overlap or underlie the adjacent feature, whereas a structure or feature that is disposed “adjacent” another feature might not have portions that overlap or underlie the adjacent feature.

Spatially relative terms, such as “under”, “below”, “lower”, “over”, “upper”, “proximal”, “distal”, and the like, may be used herein for ease of description to describe one element or feature's relationship to another element(s) or feature(s) as illustrated in the figures. It will be understood that the spatially relative terms can encompass different orientations of a device in use or operation, in addition to the orientation depicted in the figures. For example, if a device in the figures is inverted, elements described as “under” or “beneath” other elements or features would then be oriented “over” the other elements or features.

As used herein, the phrase “at least one of X and Y” can be interpreted to include X, Y, or a combination of X and Y. For example, if an element is described as having at least one of X and Y, the element may, at a particular time, include X, Y, or a combination of X and Y, the selection of which could vary from time to time. In contrast, the phrase “at least one of X” can be interpreted to include one or more Xs.

It will be understood that, although the terms “first”, “second”, etc. may be used herein to describe various elements, these elements should not be limited by these terms. These terms are only used to distinguish one element from another. Thus, a “first” element discussed below could also be termed a “second” element without departing from the teachings of the present disclosure. The sequence of operations (or steps) is not limited to the order presented in the claims or figures unless specifically indicated otherwise.

While aspects of this disclosure have been particularly shown and described with reference to the example aspects above, it will be understood by those of ordinary skill in the art that various additional aspects may be contemplated. For example, the specific methods described above for using the apparatus are merely illustrative; one of ordinary skill in the art could readily determine any number of tools, sequences of steps, or other means/options for placing the above-described apparatus, or components thereof, into positions substantively similar to those shown and described herein. In an effort to maintain clarity in the Figures, certain ones of duplicative components shown have not been specifically numbered, but one of ordinary skill in the art will realize, based upon the components that were numbered, the element numbers which should be associated with the unnumbered components; no differentiation between similar components is intended or implied solely by the presence or absence of an element number in the Figures. Any of the described structures and components could be integrally formed as a single unitary or monolithic piece or made up of separate sub-components, with either of these formations involving any suitable stock or bespoke components and/or any suitable material or combinations of materials. Any of the described structures and components could be disposable or reusable as desired for a particular use environment. Any component could be provided with a user-perceptible marking to indicate a material, configuration, at least one dimension, or the like pertaining to that component, the user-perceptible marking potentially aiding a user in selecting one component from an array of similar components for a particular use environment. A “predetermined” status may be determined at any time before the structures being manipulated actually reach that status, the “predetermination” being made as late as immediately before the structure achieves the predetermined status. The term “substantially” is used herein to indicate a quality that is largely, but not necessarily wholly, that which is specified—a “substantial” quality admits of the potential for some relatively minor inclusion of a non-quality item. Though certain components described herein are shown as having specific geometric shapes, all structures of this disclosure may have any suitable shapes, sizes, configurations, relative relationships, cross-sectional areas, or any other physical characteristics as desirable for a particular application. Any structures or features described with reference to one aspect or configuration could be provided, singly or in combination with other structures or features, to any other aspect or configuration, as it would be impractical to describe each of the aspects and configurations discussed herein as having all of the options discussed with respect to all of the other aspects and configurations. A device or method incorporating any of these features should be understood to fall under the scope of this disclosure as determined based upon the claims below and any equivalents thereof.

Other aspects, objects, and advantages can be obtained from a study of the drawings, the disclosure, and the appended claims.

I claim:

1. A brake system for actuating a plurality of wheel brakes comprising first and second pairs of wheel brakes, the system comprising:
a reservoir;
a motor-driven master cylinder operable during a normal non-failure braking mode by actuation of an electric motor of the master cylinder to generate brake actuating pressure at first and second MC outputs for hydraulically actuating the first and second pairs of wheel brakes, respectively;
a secondary power transmission unit configured for selectively providing pressurized hydraulic fluid at first and second PTU outputs for actuating the first and second pairs of wheel brakes in at least one of a normal non-failure braking mode and a backup braking mode, the secondary power transmission unit including an electric PTU motor configured to selectively pressurizing the hydraulic fluid by transmitting rotary motion to at least two pump pistons, each pump piston providing pressurized hydraulic fluid to a corresponding one of the first and second PTU outputs, each of the first and second PTU outputs providing fluid to a corresponding one of the first and second pairs of wheel brakes; and
an electronic control unit for controlling at least one of the power transmission unit and the master cylinder;
wherein the secondary power transmission unit is indirectly fluidly connected to the reservoir to selectively draw hydraulic fluid therefrom.

2. The brake system of claim 1, including an iso/dump control valve arrangement associated with each wheel brake of the plurality of wheel brakes, each iso/dump control valve arrangement being controlled by the electronic control unit.

3. The brake system of claim 2, wherein each iso/dump control valve arrangement is in fluid communication with both a selected one of the first and second MC outputs and a selected one of the first and second PTU outputs for selectively receiving pressurized hydraulic fluid therefrom.

4. The brake system of claim 1, wherein the motor-driven master cylinder is a dual-chamber master cylinder.

5. The brake system of claim 1, wherein the secondary power transmission unit includes a plurality of pump pistons associated with each of the first and second PTU outputs.

6. The brake system of claim 1, including
a first traction control iso valve hydraulically interposed between the motor-driven master cylinder and the first pair of wheel brakes via the first MC outlet; and
a second traction control iso valve hydraulically interposed between the motor-driven master cylinder and the second pair of wheel brakes via the second MC outlet.

7. The brake system of claim 6, including an iso/dump control valve arrangement associated with each wheel brake of the first and second pairs of wheel brakes, wherein the first traction control iso valve is hydraulically interposed between the motor-driven master cylinder and the iso/dump control valve arrangements of the first pair of wheel brakes, and wherein the second traction control iso valve is hydraulically interposed between the motor-driven master cylinder and the iso/dump control valve arrangements of the second pair of wheel brakes.

8. The brake system of claim 1, wherein the electronic control unit is a first electronic control unit controlling the motor-driven master cylinder and the brake system includes a second electronic control unit controlling the secondary power transmission unit.

9. The brake system of claim 8, including an iso/dump control valve arrangement associated with each wheel brake of the first and second pairs of wheel brakes, wherein the first electronic control unit controls each of the iso/dump control valve arrangements.

10. The brake system of claim 1, including
a first traction control iso valve hydraulically interposed between the motor-driven master cylinder and the first pair of wheel brakes via the first MC outlet; and
a second traction control iso valve hydraulically interposed between the motor-driven master cylinder and the second pair of wheel brakes via the second MC outlet;
wherein the second electronic control unit controls the first and second traction control iso valves.

11. The brake system of claim 1, including a deceleration signal transmitter configured to provide a braking signal, in a wired or wireless manner, corresponding to a desired braking action by an operator of the vehicle, wherein the electronic control unit controls at least one of the secondary power transmission unit and the motor-driven master cylinder responsive to the braking signal.

12. The brake system of claim 1, wherein each of the first and second MC outputs is in fluid communication with a pump input of at least one pump piston for selectively supplying pressurized hydraulic fluid thereto, the secondary power transmission unit selectively boosting pressure of the pressurized hydraulic fluid to supply boosted-pressure hydraulic fluid to at least one of the first and second PTU outputs in at least one of a normal non-failure braking mode and a backup braking mode.

13. The brake system of claim 12, including at least one check valve interposed hydraulically between the secondary power transmission unit and the reservoir, wherein the secondary power transmission unit selectively pulls hydraulic fluid from the reservoir through the at least one check valve to supplement pressurized hydraulic fluid from the motor-driven master cylinder.

14. The brake system of claim 12, wherein the secondary power transmission unit selectively pulls hydraulic fluid from the reservoir through the motor-driven master cylinder.

15. The brake system of claim 14, wherein the motor-driven master cylinder includes at least one return spring biasing open a replenishment fluid path between the secondary power transmission unit and the reservoir responsive to de-energization of the motor-driven master cylinder.

16. The brake system of claim 12, including a pressure sensor sensing a pressure of the pressurized hydraulic fluid at at least one of the first and second MC outputs, the pressure sensor providing a pressure signal to the electronic control unit responsive to the sensed pressure.

17. The brake system of claim 1, wherein the secondary power transmission unit is operative to provide pressurized hydraulic fluid to at least one of the first and second pairs of wheel brakes in a slip control condition of a normal non-failure braking mode.
